(19) United States
(12) Patent Application Publication
(10) Pub. No.: US 2009/0277451 A1
(43) Pub. Date: Nov. 12, 2009

(54) STRAPLESS CANTILEVERED RESPIRATORY MASK SEALABLE TO A USER'S FACE AND METHOD

(76) Inventor: Stanley Weinberg, Los Angeles, CA (US)

Correspondence Address: SNELL & WILMER LLP (OC), 600 ANTON BOULEVARD, SUITE 1400, COSTA MESA, CA, 92626, US

(21) Appl. No.: 12/506,106

(22) Filed: Jul. 20, 2009

Related U.S. Application Data
(63) Continuation-in-part of application No. 11/598,321, filed on Nov. 13, 2006.

(51) Int. Cl. A62B 7/10

(52) U.S. Cl. 128/206.14; 128/206.16

(57) ABSTRACT

A facial mask for filtering ambient air is formed from a pre-form of a multilayer flexible flat filter member with solid plastic side ribs of a size to extend the filter member over the mouth and nostrils of the user. The flat pre-form filter member can have a trapezoidal perimeter with an endless band of a hypoallergenic adhesive tape encircling a perimeter opening of the filter member and operable for sealing with the user's skin to prevent leakage over extended use. Portions of the adhesive tape can self-seal to form a structural base for maintaining a central concavity by cantilevering the side ribs to ensure a large filtration area offset from the nostrils and mouth of the user. The flexible filter material can further include an activated carbon layer.

### RELATED APPLICATIONS

The present application is a continuation-in-part application from U.S. application Ser. No. 11/598,321 filed on Nov. 13, 2006.

### BACKGROUND OF THE INVENTION

1. Field of the Invention

The present invention is directed to a respiratory electrostatic facial mask and more particularly, to an improved configuration of a facial mask that can be subjectively configured by the user to seal on the user's face to prevent leakage while still maintaining a large filter area offset from the user's face, a method of manufacturing and method of use.

2. Description of Related Art

Respirator products such as facial masks are frequently used as a tool to protect workers in industrial environments, medical personnel and the general public against contaminants that are airborne, including organic and non-organic airborne particles and various diseases such as viruses and bacteria that can be carried as airborne particles. The National Institute for Occupational Safety and Health (NIOSH) has proposed various procedures for certifying respirator products in correlation with the Center for Disease Control and Prevention. Frequently there is a recommendation for training to ensure that the user of such a mask have adequate knowledge on how to properly employ such devices. NIOSH Federal Respiratory Regulations 42 CFR Part 84 is the standard used for industrial applications.

A representative or surrogate mask is designated and tested in occupational settings as acceptable for a category of users. However, the use of surrogate masks can be time consuming and expensive and does not guarantee that the size selection for actual masks will replicate the exact same fit and protection on the subject actually tested.

Quantitative respiratory fit testing is frequently proposed with an emphasis to try and eliminate any leakage in an interface between the user's face and the mask. No matter how effective the filter material is in stopping airborne particles, any leak about the edges of the facial mask can negate the advantages of the filter material. Frequently, respiratory masks are maintained on a user's face with a resilient cord or cords and the mask can have a pre-formed conical configuration to extend over the nose and mouth of the user. See U.S. Pat. No. 5,357,947. Such respiratory facial masks can frequently qualify for an N95 rating which defines the penetration of particles through the filter material only. Leakage, however, around the mask can negate the value of such a mask to the user and belie the N95 rating effect. Masks may also use a bendable wire metal nose strip to adjust for contours of the face such as the nose.

The prior art also has proposed providing sealing flaps with a pressure sensitive adhesive to a face engaging side of a facial mask in a medical environment, such as disclosed in U.S. Pat. No. 3,357,426. Other examples of a strapless respiratory facial mask that can be customized to the contours of a wearer's face can be seen in U.S. Pat. No. 5,918,598 and U.S. Pat. No. 6,196,223.

However, there is a further need to improve the performance of a respiratory facial mask to meet the Centers for Disease Control (CDC) and the National Personal Protection Technology Laboratory (NPPTC) of NIOSH standards of Total Inward Leakage (TIL). RCT-APR-STP-0352 for measuring the penetration of particles through the filter medium, any exhalation valves and between the respirator and the user's face.

It is also desirable to provide a universal fit so that a respiratory face mask can fit different facial contours while meeting NIOSH N99, N100 and P99, P100 standards.

There is still a need in this field of respirator facial mask filters to provide a highly effective respiratory mask that can be economically manufactured and easily donned and used by an unskilled person to prevent face interface leakage while maintaining a relatively comfortable fit and increasing the ability to prevent penetration into or out of the facial mask. Obviously, economics can bear an important component in order to effectively provide a facial mask that can assist the general population from potential airborne particulate matter including viruses and bacteria of 0.1 mkm particles (microns) at an appropriate pressure drop to provide a comfortable breathing resistance factor for the user. These goals must be obtained in an economical manner in order to make such a respirator facial mask available to the general population while effectively sealing the respirator facial mask to the face of the user.

### SUMMARY OF THE INVENTION

The present invention provides a strapless formed facial respiratory mask for filtering and purifying ambient air and includes a flexible filter member of a size to extend over the mouth and nostrils of a user to enable the user to breathe and talk through the facial mask in a comfortable manner for preferably 8 hours. The filter member includes multiple layers, for example, of a tribo-charged mixed fiber arrangement to block airborne particles of 50 nm size while providing 25 mm or less of exhalation pressure resistance and a plurality of polyethylene layers. The filter member is offset from the user's mouth and nostrils by side rib members. A hypoallergenic adhesive can extend about the perimeter of the filter member and enable the user to self-seal the facial mask with the user's skin across the nose and mouth. The flexible filter member can be a non-woven fiber material of two electrically dissimilar synthetic polymers which are processed to create a charge transfer. An acrylic fiber can serve as an insulator to ensure a stable and permanent charge transfer.

Alternatively, an intermediate layer of a flexible activated carbon can be felt layer positioned or laminated between the first and second layers of the fiber material as an alternative embodiment. The combination of the multiple layers can be approximately 0.32 cm thick while any additional activated carbon particles in a flexible carrier matrix can add approximately 0.2 cm to the thickness.

In manufacturing the respiratory facial mask, layers of filter material can be cut and folded over to form a substantially isosceles trapezoid shape with the shorter parallel base portion being folded and the longer parallel portion being open and folded along the open edge to cover the tribo-charged filter material with the plurality of polyethylene layers. The cut equal length sides are welded together to form solid flexible side ribs and an adhesive strip or band is adhered around an inside perimeter of the open base portion to enable a sealing fit on the user's face.

The welded equal length side ribs provide a degree of rigidity to maintain an interior cavity cantilevered from the user's face to assure a large flow area of filtration material. that is offset from the mouth and nostrils of the user during inhalation pressure differentials.

In a preferred embodiment, the respiratory facial mask can have a pre-formed isosceles trapezoid shape to provide an approximately 480 cm² of filtration area. As supplied to the user, a medical grade adhesive such as a hypoallergenic acrylate adhesive band of tape extends approximately 4 cm in width endlessly about the openable base perimeter of the facial mask. A tribo-charged filter media supports the adhesive tape and a releasable paper strip covers the adhesive with appropriate cuts or slits on either side of the length of the pre-form facial mask. The outer surface of the facial mask is formed of a set of a plurality of very thin melt blown tri-layers on the exterior of the tribo-electrically charged polypropylene/acrylic filter media layer and only secured together around the perimeter. The outer surface can act as a pre-filter to prevent loading of the bottom filter material layer.

The respiratory facial mask can provide a substantially “one size fits all” arrangement without a preferred top or bottom in mounting on a user's face, as long as the flexible side ribs are positioned to align with the sides of the user's face.

The respiratory facial mask does not require metal nose clips or fasteners nor does it use exhalation values.

Our respiratory facial mask can exceed the NIOSH P100 level of protection using a DOP challenge aerosol that allows certification for oil as well as non-oil atmospheres. The P100 level of protection also does not have a time usage constraint as do the other NIOSH disposable protection levels such as N95. Our respiratory facial mask can also incorporate a carbon layer to for nuisance gases and odors.

Optionally, a film of an antimicrobial layer such as silver nano particles or silver ion zeolite can be sprayed on a polyethylene surface layer. As a further option, a thin intermediate layer of a carbon impregnated non-woven felt layer can be included to further treat the air flow.

A method of sizing a universal user pre-form mask to a specific size and contour of face is provided. The user can take an initial pre-form flat flexible filter mask and draw back the top paper release liner by pulling at extended paper tabs. The user can pinch or tent the flexible fiber member while placing it over the bridge of the nose just below the eye sockets in order to fit and cover the nostrils and extend across the mouth of the user. The bottom paper release liner is them removed by pulling the extended paper tab. With the user's mouth closed, the lower adhesive is centered under the chin and as close to the neck as possible. Pressure is applied to anchor the adhesive to the skin. Using the fingertips of both hands the top and bottom layers are pinched together at the sides and pressed firmly against the cheeks.

The user should open his/her mouth wide to suck the mask into position and subsequently the user's fingertips should firmly press against the adhesive layer to ensure that there are no gaps or wrinkles to ensure an airtight fit. When a user is comfortable that the mask has now been subjectively customized to a concave filter configuration approximating the contours of the user's face, the user can then firmly attach the respiratory facial mask in a sealing manner around the entire perimeter of adhesive to the face of the user. Additional pressing or pinching can assist in pulling the facial mask into full sealing contact with the user's face.

Preferably, a visual check in a mirror or by a fellow worker is performed to ensure a tight adhesion of the mask to the user's face with no gaps between the mask and the chin.

The user can breathe in and out forcefully and the mask should billow out slightly on exhalation and collapse slightly inward on inhalation between the side ribs indicating that the mask has a protective face seal.

The welded side ribs will provide a structural support and integrity to the concave configuration, while still maintaining an effective utilization of the total filtration area. The perimeter adhesive layer will maintain the folded over edges of the filter layers so that the polyethylene surface is maintained on the entire exterior of the facial mask. The selected adhesive material will actually increase its adhesive force to the face as it sets up and when it is time to remove the facial mask, the welded side ribs can be grasped to assist in effectively peeling the spent respiratory facial mask from the face of the user.

The exterior three layers of floating melt blown electrostatically charged polypropylene assists in preventing the accumulation of particles on the surface of the mask and can provide an exterior support surface for an antimicrobial film layer.

In removing the face mask, the skin should be supported by one hand while the other hand pulls the face mask free to reduce tension on the skin. Opening and closing the mouth can assist in dislodging the adhesion bond. Starting at the lowest point below the chin, the user should begin by loosening the adhesive at the edge of the face mask by pulling it back over itself slowly, keeping it close to the skin surface.

If the mask is used in a hostile environment the outer surface of the face mask might contain harmful particles. The user should avoid touching the exterior surface when removing the face mask and should wash his/her hands thoroughly after discarding.

The facial mask can be provided in a pre-form flat configuration to assist in manufacturing and packaging of a plurality of stacked, flat facial respiratory masks. The preferred embodiment of an isosceles trapezoid configuration of the facial mask assists in providing a subjective fitting to seal the perimeter of the mask to the face of the user, while permitting it to flex to accommodate movements of the chin for talking and breathing. The significantly increased filtration area lowers the resistance for both exhaling and inhaling by the user. However, other variances of this trapezoid shape can also be used with flanges and side ribs for a cantilevered extension from a user's face to provide the advantages of the present invention.

The user can easily create an appropriate facial mask with a customized size fit for the user and then sequentially seal it airtight to the user's face.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a schematic perspective view of a first embodiment of the facial mask of the present invention mounted on a user;

FIG. 2 is a perspective exploded view of the filter material;

FIG. 3 is a partial schematic view of the filter material prepared for receiving an adhesive strip;

FIG. 4 is a schematic partial view of the filter material folded over into a rectangular configuration;

FIG. 5 is a perspective view disclosing a trimming and ultrasonic welding of the folded over filter material;

FIG. 6 is an open end elevational view of the facial mask;

FIGS. 7-11 are schematic views disclosing the manner of applying the facial mask;

FIGS. 12-13 disclose a manner of removing the facial mask after use;

FIG. 14 is a chart showing a penetration particle test and breathing resistance test of a preferred configuration of a facial respiratory mask;

FIG. 15 is a partial cross-sectional view of a preferred embodiment; and

FIG. 16 is a schematic illustration to show the relationship of the adhesive seal to the face and the enlarged interior cavity for the nostrils and mouth.

### DETAILED DESCRIPTION OF THE PREFERRED EMBODIMENTS

Reference will now be made in detail to the preferred embodiments of the present invention which set forth the best modes contemplated to carry out the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the issued claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures and components have not been described in detail as not to unnecessarily obscure aspects of the present invention.

The contents of the co-pending U.S. patent application Ser. No. 11/598,321 is incorporated herein by reference.

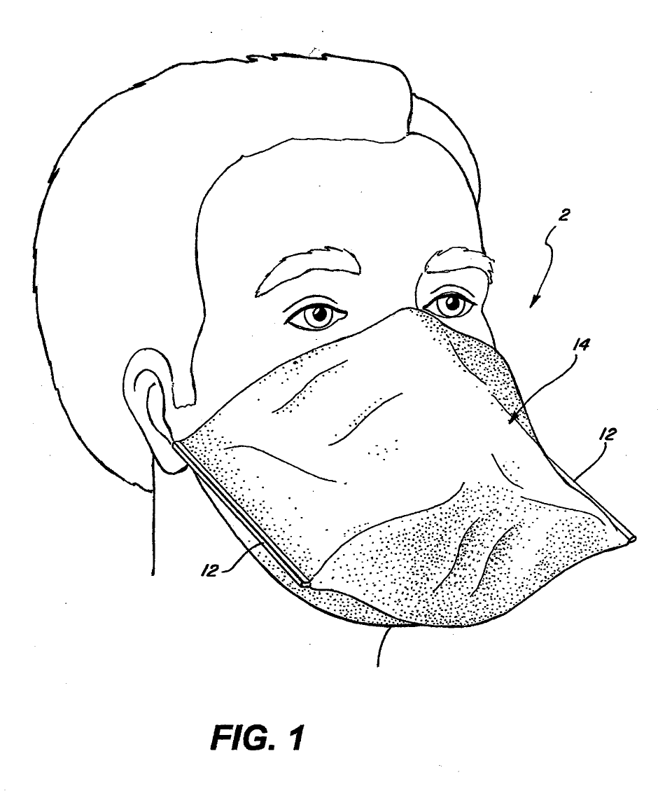

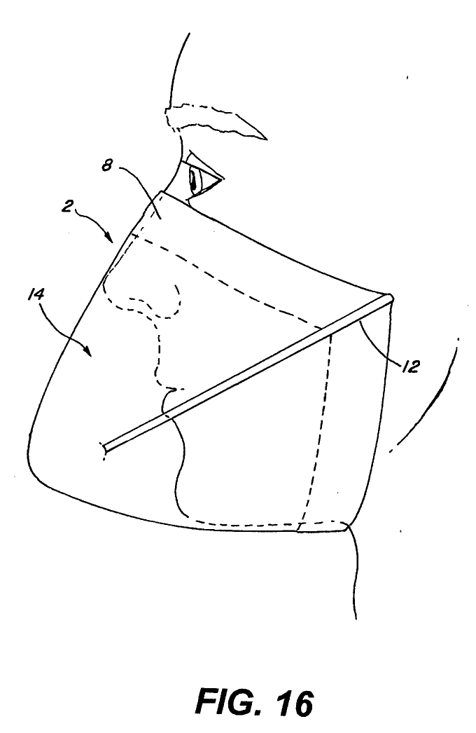

Referring to FIGS. 1 and 16, a respiratory facial mask 2 of a strapless configuration is disclosed schematically mounted on a face of a user to prevent and lower the risk of both inhalation and discharge of airborne particles of a size that would include live bacteria and viruses such as SARS, influenza A (H1N1) and Avian influenza such as H5N1. The H5N1 viral particle is generally spherical in configuration and can be from 50 to 180 nanometers in aerodynamic size. Such particles can be aerosolized in water droplets and deposited on open surfaces or can become airborne by coughing or sneezing of the affected victim. Evaporation and low humidity can reduce the active viral particle to below 0.5 microns.

As can be appreciated, it is not only important that the filtering material of the facial mask be able to prohibit both the inhalation and exhalation of such size particles, but that the masks be sealed to prevent any leakage between the interface of the person's skin and the mask. It is not uncommon to have over 20% total inward leakage with CDC/NIOSH certified respirator masks when the faceseal leakage is not considered. In fact this faceseal leakage can be much worse, the higher the actual filtration efficiency in conventional respirator mask, because the particles will take a path of least resistance so at the P100 level, faceseal leakage can be very high.

The facial mask 2, shown in FIGS. 1 and 16, has sufficient flexibility to permit an adaption to most face configurations of potential users. The active filtration surface area can be approximately 480 cm². This range permits coverage for not only a significant number of the population of users but provides a sufficient area to permit adequate levels of exhalation and inhalation pressure for the user.

As can be readily appreciated, in a toxic or infectious environment, additional protective measures should be undertaken including goggles and covering of the user's skin while ensuring that the disposal of such a mask be done with protective gear such as rubber gloves with an appropriate disposal receptacle for the potentially contaminated mask.

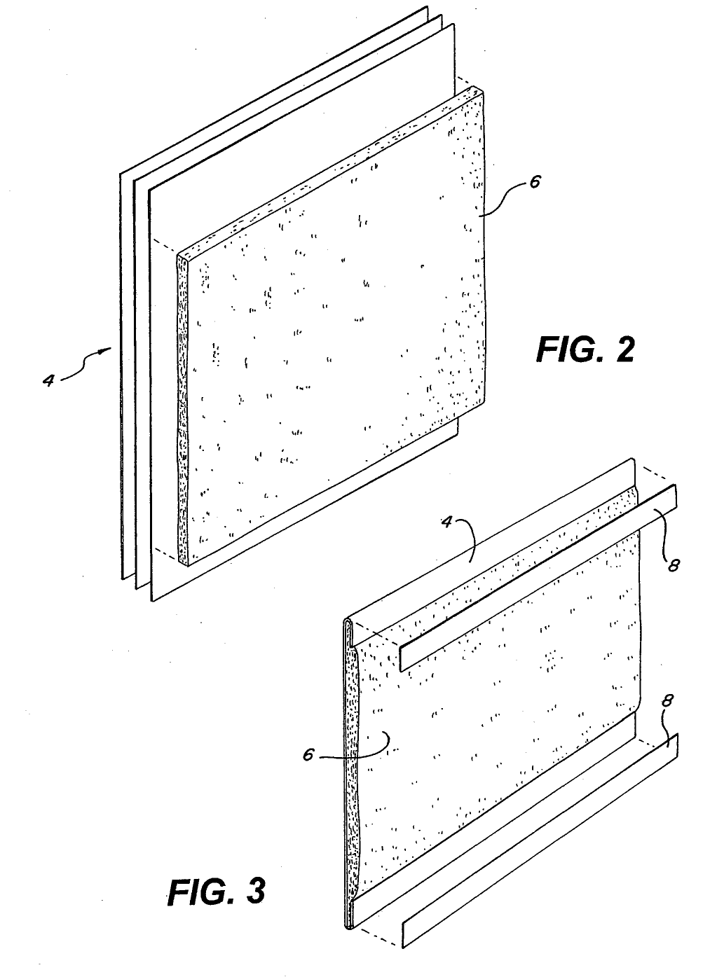

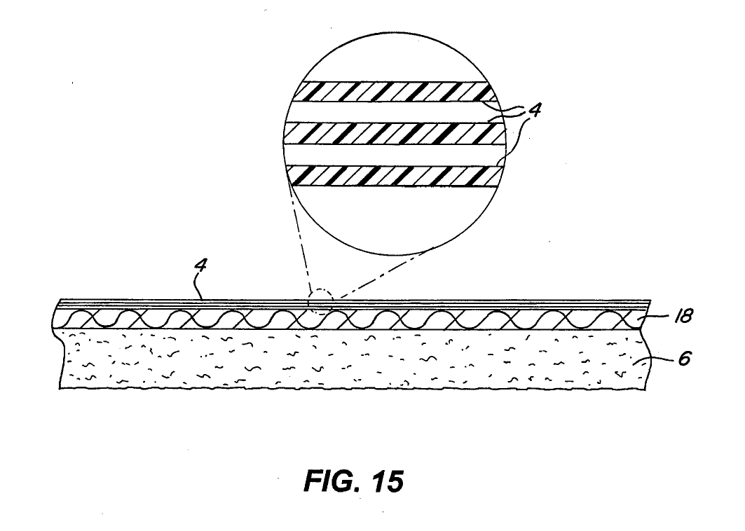

A medical grade adhesive tape that is conformable and can flexibly seal, such as a hypoallergenic pressure sensitive acrylate adhesive tape, is used to lock the filtration media of the facial mask to the user's face. An example of such a tape is the 3M Medical Nonwoven Tape #9917 sold by 3M Medical Specialties although other adhesive members can be used. The facial mask 2 is designed to meet the standards associated with a NIOSH style negative pressure respiratory facial mask of sm, N, R or P series. The adhesive forms a bond to the skin creating a particle exclusion zone inside the facial mask 2 and preventing the inhalation of submicron particles from leaking through the periphery of bonded seal to the face. Referring to FIG. 2, an exploded view of filter activated layers of the facial mask 2, is disclosed as a pre-form with a rectangular shaped perimeter. A plurality of high loft melt blown sheets, such as three each of approximately 0.13 mm in thickness and 42 g/m² are used to form a free floating pre-filter as a surface layer for the respiratory mask and can impede the accumulation of particles on the surface. In a preferred embodiment three sheets of polyethylene melt blown 4 having a width, W, of approximately 28 cm and a length, L, of 25 cm are stacked together, see FIG. 15. An interior layer of a tribo-charged mixed fiber of a non-woven needled felt is disclosed as a second layer 6. The mixed fiber nonwoven needle felt can be composed of one layer of polypropylene/acrylic from Hollingworth & Vose Air Filtration Ltd sold as Technost at 300 g/m².

This filter material is an electrostatically charged needle felt of two electrically dissimilar synthetic polymers which are processed to create a charge transfer between the two different types of coarse fibers with both positive and negative charges present on the fiber surfaces. As the acrylic fiber, in the blend, is an extremely effective insulator the charge transfer is stable and permanent. This can enhance filtration efficiency for viral sized particles. The construction yields very low breathing resistance and very low viral particle penetration even at high respiration rates.

For instance, one preferred embodiment with a felted carbon layer, shown in FIG. 15, provides no more than 0.004% to 0.007% penetration rate when the respiratory filters were loaded to 200±25-35 g Dioctyl Phthalate to determine their maximum penetration, at a flow rate of 85 L/min. with an exhalation resistance of approximately 11 mm (H₂O) or less, making it eligible for a NIOSH P-100 certification and HEPA certification. The NIOSH limit is ≦0.03% penetration rate with a breathing resistance (mm H₂O) of ≦50.0 mm.

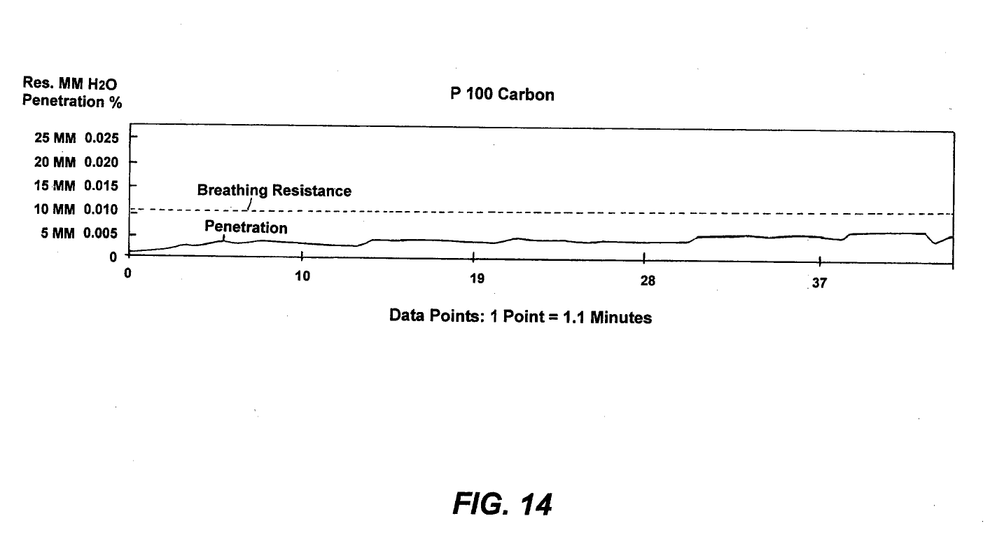

FIG. 14 provides, on the left side of the graph, a penetration rate as a percentage rate and also a breathing resistance rate in mm of H₂O. The bottom scale represents Data Points with 1 Point=1.1 minutes. The test was conducted pursuant to:

42 CFR part 84.181, P100 Filter Efficiency Test for Filters/Masks

42 CFR part 84.180, P100 Airflow Resistance

NIOSH Procedure No. RCT-APR-STP-0057, 0058, 0059.

The equipment was a TSI8130 Automated Laser Particle Counter Test Bench configured for Dioctyl Phthalate (DOP) aerosol testing. (GAUGE-020). All fixtures, tubing and couplings were cleaned D.O.P. prior to the start of each test sequence to guard against possible cross contamination of data. Filters were challenged to a nebulized Dioctyl Phthlate (DOP) aerosol at a relative humidity of 25+/−5° C. and were neutralized to a Boltzmann equilibrium state. Particle size distribution was verified to a count median diameter of 0.185+/−0.020 microns, with a geometric standard deviation not exceeding 1.6.

In accord with standard NIOSH protocol, a minimum of three samples were assessed to full loading conditions by depositing an initial 200 mg+5 additional data points of 5-7 mg DOP aerosol at a flow rate of 85 liters per minute to determine the filter performance profile. Flow rate was monitored every 5-6 minutes on average and adjusted to maintain a flow rate of 85 LPM+/−4 LPM.

Referring to FIG. 15, a further modification of the present invention includes adding a flexible layer of an activated carbon felt layer 18 of 2 mm in thickness that is porous to air flow, and can be suspended intermediate the first layers 4 (total combined thickness of 1 mm) and second layer 6 of fiber media with a thickness of 5 mm. The carbon material has a capacity of trapping and removing odors and, to a degree, smoke, as an additional filtration feature of an alternative embodiment of the present invention.

The thickness of the second layer 6 fiber media can be approximately 5 mm and the effective surface area can be in the range of 480 cm² to provide an optimized available breathing area so that a low face velocity of transit particles and penetration effects can be minimized. The pre-form length L can be 24 cm and the pre-form width W can be 25 cm with an overall thickness of approximately 1 cm.

A hypoallergenic adhesive layer 8 shown in FIG. 3 is provided about the lengthwise edges of the filter media 6 and can be applied as a tape, approximately 4 cm wide. A silicone release paper liner 10 with a two-sided differential silicon release can be mounted over the adhesive layer 8 to protect it prior to use. The adhesive layer 8 has a capacity of adhering to a test plate of stainless steel with a force of 27 ounces/inch width. This medical grade adhesion perimeter is highly moldable and conformable and can flow during pressure sensitization and set into ultra tiny skin imperfections, contours and textures to form a face seal against pathogen sized particles. The adhesive can be applied with a tape carrier of a white spun lace polyester/rayon blend. The adhesive being applied on both sides of the carrier and of a type, for example, sold by 3M as medical non-woven tape #9917. It was found that the relative adhesion or bonding of this adhesive tape to the skin increases over time and can double over a period of four hours from its initial application to counteract perspiration and skin oils generated during an 8 hour period of use. Thus, the ability to peel the facial mask off of the user after use is of value.

The exterior surface of the facial mask has a thin melt blown tri layer and assists in preventing the accumulation or loading of particulate material on the exterior of the turbo electrically charged polypropylene acrylic filter media layer. Optionally, a thin film of an antimicrobial layer such as a silver nanoparticle or silver ion zeolyte can be sprayed on the glossy surface layer to inhibit any growth of micros.

As can be seen in FIG. 1, flanges or plastic side ribs 12 are cantilevered approximately horizontally from the user's face to assist in tenting the filter material 14 across the nostrils and mouth of the user without blocking either the oral cavity or nostrils of the user. This arrangement also provides an extended surface area to lower the inhalation and exhaustion resistance pressure on the user. This arrangement also facilitates the capacity of the user to speak clearly through the mask while assuring an airtight seal.

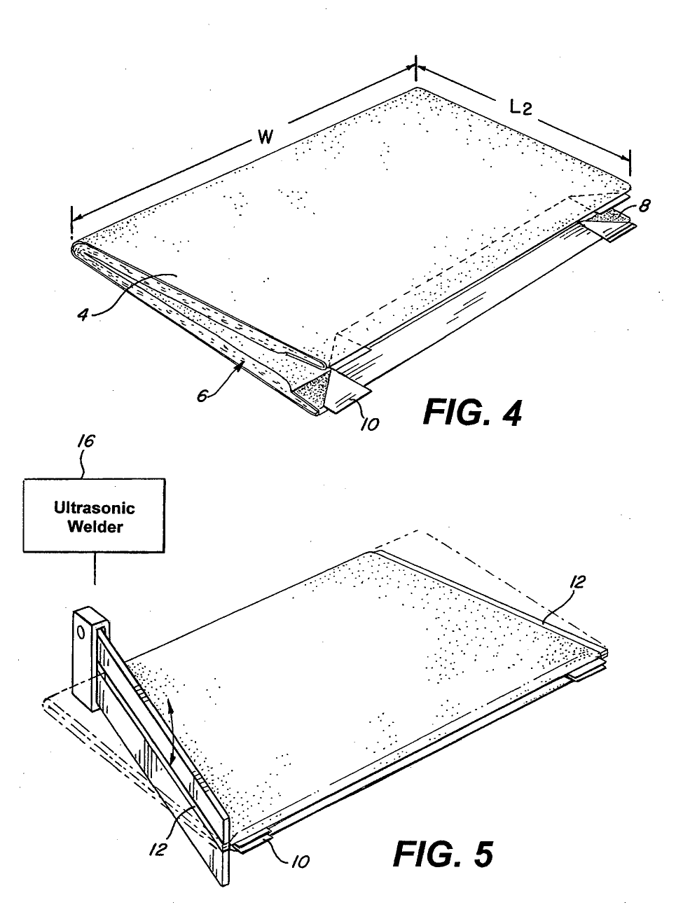

In FIG. 3, opposite ends of the three sheets of melt blown 4 have been folded over to capture the corresponding ends of the turbo charged mixed fiber or second layer 6. The adhesive layer, which can be in the form of a tape layer 8, is then applied to both of the upper and lower edges, this assures the melt blown sheets 4 form the exterior surface of the facial mask 2. Preferably, a silicone release paper liner 10 is provided on one side of the adhesive tape carrier and the opposite ends of the paper liner is folded back to expose the acrylate adhesive, as shown in FIG. 4.

The side edges of the rectangular configuration of FIG. 5 is then subject to pressure during a heating step such as an ultrasonic welding to integrally form the solid plastic flanges or side ribs 12. The preferred form of providing the sealing step can be an ultrasonic welder 16 that also has the capacity of cutting the pre-formed rectangular configuration of FIG. 4 into an isosceles trapezoidal configuration as shown in FIG. 5. The flanges or side ribs 12 are formed from both the plastic based filter material 4 and 6 and also the plastic adhesive material adjacent the open edges. The side rib 12 have a thickness of approximately 1 mm and a width of 2 mm during application of heat and pressure from an applying surface of the ultrasonic welder 16. Alternatively, an application of heat from another source along the desired cut line can fuse the filter material and adhesive material into the side ribs 12.

This configuration provides significant structural support and strength while maintaining the concavity of the filter material 14 in an appropriate cantilever position away from the nostrils and mouth of the user, for example, a force of 340 grams can be supported by each side rib 12 along their axial length before deflecting. At the same time, any transverse movement, relative to the longitudinal axis of the flanges or side ribs 12, will still provide flexibility and safety to the user.

Thus, the present invention can be provided in an initial flat and preferably trapezoidal configuration with a base opening having an adhesive layer 8 extending around the entire perimeter of the opening of the filter material 14. The filter material 14 blocks particles of at least 50 nm size while providing 25 nm or less of inhalation and exhalation breathing pressure resistance. Preferably, the filter material 14 will block ultrafine fractions or particle sizes of 0.3 micron particle penetrations of about 0.005% maximum at 85 liters per minute. Breathing resistance for both inhalation and exhalation can be 11 nm H₂O or less for our respiratory mask dimensions pursuant to 42 CFR §84.180 and test protocols of NIOSH RCT-APR-STP-0003 (Exhalation Resistance Test) and RCT-APR-STP-0007 (Inhalation Resistance Test), thus, enabling our facial mask to qualify for NIOSH P100 certification. Note, NIOSH requirements are only 0.03% penetration at 50 mm H₂O exhalation resistance.

| | Maximum Allowable | | |
|---|---|---|---|
| | Resistance | Actual Resistance | |
| | (MM of H2O) | (MM of H2O) | |
| Sample | Exhalation | Exhalation | Result |
| 1 | 25 | 8.4 | PASS |
| 2 | 25 | 8.6 | PASS |
| 3 | 25 | 7.9 | PASS |

| | Maximum Allowable | | |
|---|---|---|---|
| | Resistance | Actual Resistance | |
| | (MM of H2O) | (MM of H2O) | |
| Sample | Inhalation | Inhalation | Result |
| 1 | 35 | 7.9 | PASS |
| 2 | 35 | 7.6 | PASS |
| 3 | 35 | 7.6 | PASS |

Since the filter material 14 and the solid rib or flange members 12 are integrally formed during the manufacturing process, a relatively economical manufacturing is provided while ensuring a positive perimeter seal. Since the distal end of the trapezoidal configuration of the filter material is folded over and is relatively flexible and pliable, it does not provide any side openings. The manufacturing of the isosceles trapezoidal sides with a sealed and solid integral structural supports 12 further maintain the integrity of the sealed concavity of the respiratory face mask 2. The opening of the base of the trapezoidal configuration is provided with a generous width of adhesive material of a special medical grade 3M #9917 double coated tape to penetrate and seal the interface with the skin once the paper liner 10 is removed, see FIG. 16.

Our design provides, an all plastic fiber and lightweight, respiratory face mask 2 with no metal components while sealing the interim Technostat filter layer 6 from any exterior surface exposure. The sealing of the side edges by fusing the plastic fiber and adhesive components to form the side ribs 12 provide a structural cantilevering to insure a sufficient filtration area is spaced from the mouth and nostrils of the user, see FIG. 16.

By protecting the Technostat filter layer 6 we prevent a degrading of the electrostatic charge while still maintaining a soft and compliant opening to accommodate conforming to the user's face. The edge welding of the side edges to form the side ribs 12 both seals those edges and provides a structural form to the respiratory face mask 2. By folding the meltblown layers over the technostat which are held in place by one surface of the flat strips of 9917 double coated tape. The very thin (0.3 mm) tape thickness and one layer of meltblown (0.4 mm thickness), contact the skin and are thin enough and compliant enough to completely seal the mask against submicron particles.

The highly compliant meltblown layers and tape then are the only elements that directly contact the users skin while encapsulating the Technostat filter layer 6 and keeping it from losing an electrostatic charge.

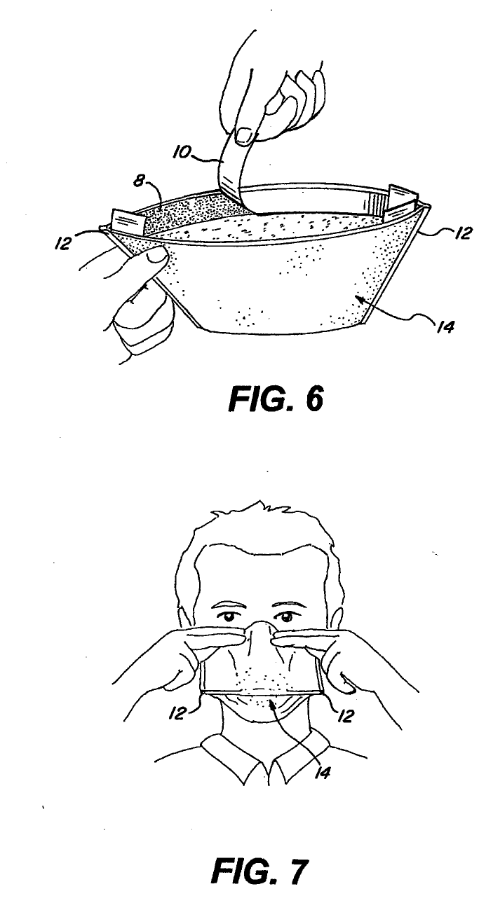

Referring to FIG. 6, the user can peel away one of the paper liners 10 to expose one half of the adhesive perimeter.

As shown in FIG. 7, a user can take the top center alignment fold as a guide and place the respiratory mask 2 over the bridge of the nose just below the eye sockets of the user. The user will press down firmly as shown in FIG. 7 over both sides of the nose.

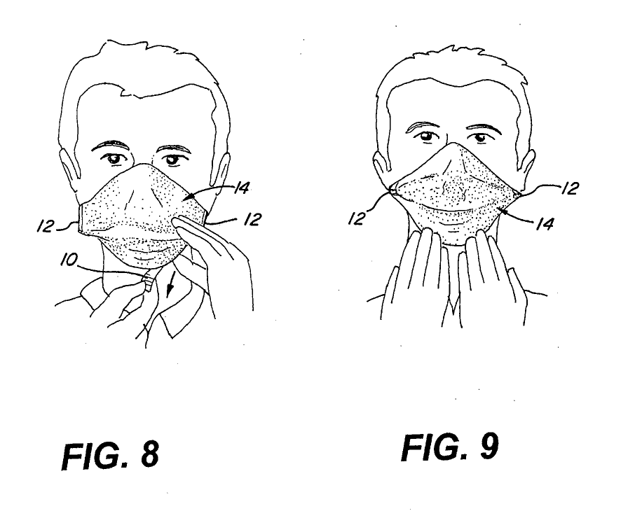

Referring to FIG. 8, the user can then remove the bottom side paper liner 10 to expose the lower perimeter side of the adhesive layer 8. As can be seen, the flanges 12 and side ribs assist in maintaining the integrity of the desired concavity for our respiratory mask 2 and facilitate the ease in which the paper liner 10 can be removed.

With the mouth of the user closed, the center of the bottom of our respirator mask 2 should be applied under the chin, as close to the neck as possible. As shown in FIG. 9, the fingertips of the user's hands can press firmly down to adhere the adhesive.

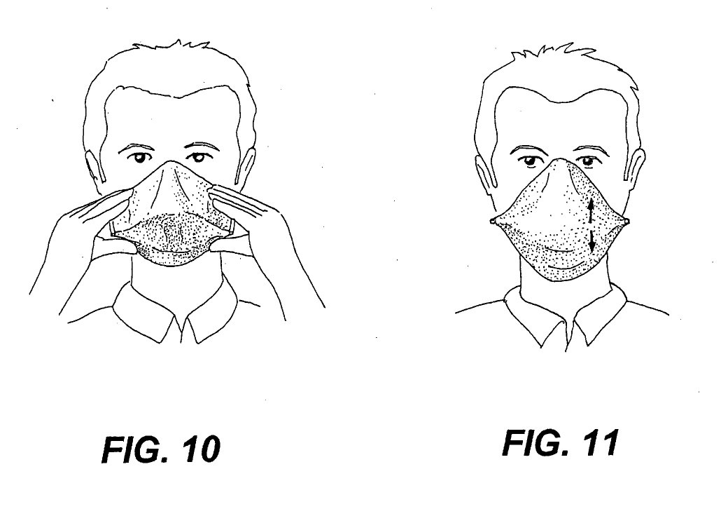

As shown in FIG. 10, the user then firmly presses the sides of the adhesive perimeter against the cheeks and jowls of the user, thereby pinching both the top and bottom layers of adhesive tightly against the user's face to ensure an airtight seal. Preferably, a co-worker could be asked to inspect the face/respiratory seal interface to ensure that there is a complete contact with the skin of the user. Note, hair should not extend across the seal.

As shown in FIG. 11, the respirator mask 2 has been mounted and is cantilevered from the face of the user in same manner as depicted in FIG. 1.

To ensure a secure, face/respiratory seal, the user can breathe in and out forcefully and as a result, the top layer of the respiratory should bellow out slightly on exhalation and should collapse inwardly slightly on inhalation, indicating that the respirator has an airtight protective face seal.

Leaks can be detected by the user on breathing in by a slight coolness on the skin at the respirator/skin interface. If leaks are detected, the user should apply more pressure to the area to seal the leak. If this cannot be achieved, the user should not enter a contaminated area and should discard the respiratory mask.

The particular adhesive described in the preferred embodiment will increase its relative adhesion or bonding to the skin to the user's face over a period of time, and can effectively double its adhesion over a period of four hours from its initial application, thereby counteracting any perspiration or skin oils generated during an eight hour period of use.

The extended filtration area of the filter material 14 can capture any moisture in the exhalation of breath by the user. Subsequent inhalation can evaporate the captured moisture and effectively lower the temperature of the inhaled air by as much as 15° F.

As can be appreciated, the respiratory mask can also serve the function of preventing a contaminated or sick person from exhaling germs or viruses to co-workers.

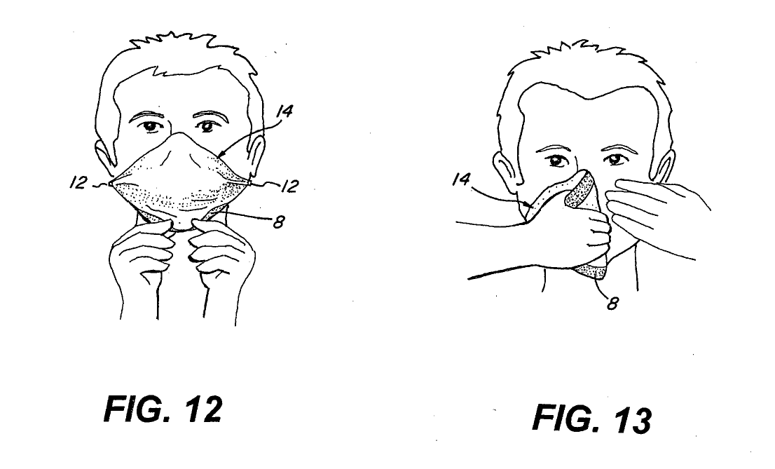

FIG. 12 illustrates the manner of removing the respiratory mask 2 from the face of the user. Skin, where appropriate, should be pulled taut for supporting the skin at the locality where the mask is being loosened from the user's face. As shown in FIG. 12, the user can start at the lowest point below the chin and begin by loosening the adhesive at the edge of the respirator by pulling it back over itself slowly, keeping it close to the skin surface. By supporting the skin with the opposite hand or fingertips, as shown in FIG. 13, there can be less tension on the skin and irritation in the removal of the respiratory mask 2. Opening and closing the jaws to their maximum during the dislodging of the adhesive bond, will assist in removing the respiratory mask 2.

It should be noted that caution should be taken in contacting the outer surface of the respiratory mask 2 if there are harmful ambient particles. Thus, avoiding the touching of the exterior surface while removing the respirator mask 2 is preferable, with the fingertips of the user contacting the internal surface of the respiratory mask during the removal process. Appropriate precautions, including washing the hands, should be taken.

A large percentage of prior art facial masks establish a face seal by using flexible bands (rubber) to pull the respirator mask against the regular facial contours. Frequently the mask is pre-molded into a cup shaped configuration and sold in that configuration. However, a respiratory facial mask is only as good as the seal to the user's face, since penetration of undesirable particulate material can occur through the seal to the face. Additionally, the respiratory mask must not only filter the inhalation breathing of the user, but also can inhibit the path of the exhaust breath. When a positive pressure is developed within the mask, it can also leak air around the sides of the mask. If the purpose of the mask is to isolate a user or patient from spreading germs, the respiratory facial mask then is attempting to filter the breath of a user. A cough can significantly increase the pressure within the mask and germs can escape around the circumferential face seal interface of the mask and the user's face. The actions of the user such as talking and facial or body movements can also disrupt any seal between the face and the mask.

Frequently, conventional facial masks will have a one-way valve or check valve on a side of the facial mask to lower the exhalation resistance to the user and dissipate heat buildup in the facial mask. Such a valve may permit an infected user with a virus to spread the virus to other people. Additionally, the valve itself may be a source of penetration since by necessity they are of a relatively low cost, and simple mechanical design. It is not uncommon to have over 20% total inward leakage in CDC/NIOSH certified N-95, N-99 and N-100 type masks. NIOSH engages in research programs recognizing these limitations in the present respiratory facial mask technologies.

There is a still a concern about the protection of healthcare workers, occupational employees and the general population in the event of a major disease outbreak or pandemic such as H5N1 avian influenza or SARS and (H1N1) swine influenza. Vaccines and effective anti-viral medicines are presently not available and the ability to provide a new vaccine production that would address a major outbreak is limited. It is common medical accepted pandemic and epidemic methodology to prevent the spread of infectious airborne crowd diseases and control of pandemics that social distancing and self quarantine is practiced. That is why schools are closed and social and entertainment venues are shut down. The present invention seals the wearer so effectively from infectious crowd diseases such as influenzas that it is in effect a mobile personal self quarantine device that creates a virtual social distancing against infectious airborne pathogens.

Economics plays a factor in that a facial mask must not only be people friendly, but relatively inexpensive while addressing the serious face seal leakage problems wherein a pathogen can bypass the filtration material and enter through small face sealed gaps directly into the nose and mouth of the user. Our facial mask is designed to provide adequate comfort for a user over an extended time, e.g. 8 hours or more while not muffling speech with low inhalation and exhalation resistance without the use of an exhalation value.

Disposable respiratory facial masks are necessary to protect workers and professionals in occupational as well as medical/dental activities from airborne viral and bacteria pathogens and aerosol contaminants and in many instances, are mandatory by OSHA and NIOSH government regulations under 42 CFR Part 84. A Portacount fit tester (TSI Corp.) has been accepted by OSHA to measure the effectiveness of a facial mask. The Portacount fit tester samples a range of particles of ambient air and compares the number of ambient air particles to the particles found inside the mask from face seal leakage as well as those particles that manage to penetrate the filter material on inhalation to establish a fit testing number for a surrogate mask. A 100:1 ratio is a minimum requirement by OSHA to pass the fit test. This test, however, only represents a benchmark and tests have shown that after a few minutes of inhalation, a masked user can inhale an infectious dose of influenza virus size particles if an infected person sneezes nearby. Thus, there is a critical need to substantially lower the risk factor of adverse health effects.

The use of surrogate masks in occupational settings is expensive and outmoded, since there is no guarantee that a size selection of an actual mask used offers the exact same fit and protection to an individual worker's face. There is also a need to provide a mask that would permit the general population to easily don and subjectively fit it to provide a substantial seal to the user's face. Needless to say, it would be highly desirable to do away with exhalation valves in the facial mask, which can spread disease if the user is infected and sneezes or coughs.

The ability to provide a universal size to fit most face types and the capabilities to subjectively mold the facial masks to enable almost zero face seal leakage, is a goal of the present invention. The ability to provide a HEPA level of particle penetration below 0.03% at 85 LPM at 0.3 microns, (which is a NIOSH requirement for N-100 certification) is an additional goal achieved in the present invention.

All overall fit factors obtained for both facial masks (total of 11 replicates) significantly exceeded the threshold of 100 (FFₒᵥₑᵣₐₗₗ=175, 299, 465, 517, 558, and 881 for the large facial mask, and FFₒᵥₑᵣₐₗₗ=218, 245, 619, 904, and 1603 for the small facial mask). Almost every action-specific fit factor obtained for both facial masks exceeded 100, although there is no minimum requirement for FF measured in specific exercise (only for the overall FF for a subject), the latter finding shows consistency of the human-subject-measured performance of both facial masks. No significant change between subjects A and B (t-test: p=0.15>0.05). No significant change between the large and small facial masks (t-test: p=0.08 0.05). SD represents a Standard Deviation taken into account an average of the number of replications of testing.

In summary, the present invention has provided an increased surface area of the filter material for filtering ambient air, while minimizing any blockage of the nasal and oral cavities. Our novel design of solid structured ribs, provided from a solidification of the filter and adhesive material, provides an integral tenting of the filter material in a cantilevered manner from the user's face, as shown in FIG. 16.

The flexible periphery of the face sealing opening utilizes a medical grade adhesive to minimize forced leakage and to anchor the cantilevered structural ribs to provide a tenting of the filter material over the nose and mouth of the user. This structure enables a low particle penetration over a broad range of particle sizes including ultrafine fractions (as MPPs<0.3 μm) while maintaining a low pressure inhalation and exhalation resistance without an exhalation value.

Further, the user is not subject to a muffled speech pattern through the respiratory mask and can experience a higher comfort level with extended wear by avoiding an accumulation of heat and moisture in the mask cavity. The trapped water vapor from a user's exhaust breath can be evaporated at 580 Cal./gm on inhalation to significantly cool the interior mask cavity.

Those skilled in the art will appreciate that various adaptations and modifications of the just-described preferred embodiment can be configured without departing from the scope and spirit of the invention. Therefore, it is to be understood that, within the scope of the amended claims, the invention may be practiced other than as specifically described herein.

What is claimed is:

1. A respiratory facial mask for filtering ambient air, comprising:
a flexible filter member of a size to extend over a mouth and nostrils of a user having an initial flat trapezoidal configuration with an opening on a base side of the trapezoidal configuration; and
an adhesive layer extending around a perimeter of the base side opening of the filter material to enable a sealing of the adhesive with the user's skin to provide a central concavity of a size to be offset from and to cover the user's mouth and nostrils, the filter member blocks particles of 50 nm size while providing 25 mm or less of inhalation and exhalation breathing pressure resistance.

2. The respiratory facial mask of claim 1 further including a pair of solid rib members cantilevered from the base side of the trapezoidal configuration to provide support for maintaining the filter material away from the user's mouth and nostrils.

3. The respiratory facial mask of claim 2 wherein the filter material and solid rib members are integral.

4. The respiratory facial mask of claim 2 wherein the solid rib members are flat plastic flanges forming opposite sides of the trapezoidal configuration and are a sealed integral continuation of the filter material forming a top and bottom of the central concavity.

5. The respiratory facial mask of claim 1 wherein the flexible filter member includes a tribo-electric charged polypropylene/acrylic filter media layer.

6. The respiratory facial mask of claim 5 wherein the flexible filter member includes a melt blown surface layer on an exterior of the polypropylene/acrylic filter media to impede accumulation of airborne particles.

7. The respiratory facial mask of claim 6 wherein the polypropylene/acrylic filter media layer has a weight of 300 grams/meter and approximately 5 mm in thickness.

8. The respiratory facial mask of claim 5, wherein a medical grade hypoallergenic acrylate adhesive band is attached to the polypropylene/acrylic filter media layer.

9. The respiratory facial mask of claim 5 further including an intermediate layer of carbon impregnated non-woven fibers.

10. The respiratory facial mask of claim 5 wherein the filter median enables a 0.3 micron particle penetrations of approximately 0.005% at 85 L/min. pursuant to NIOSH standards.

11. The respiratory facial mask of claim 5 wherein the flexible filter member has no openings for an exhaust valve.

12. The respiratory facial mask of claim 5 wherein a breathing resistance of approximately 11 mm H₂O is provided.

13. The respiratory facial mask of claim 5 wherein the adhesive layer enables an adhesive bond to increase, by a factor of 2, an adhesion force to a user's face over a period of approximately 4 hours after application to the user's face.

14. The respiratory facial mask of claim 5 wherein the flexible filter member traps breathe water vapor to cool the mask by approximately 15° F.

15. A respiratory facial mask for filtering ambient air, comprising:
a flexible filter member of a size and configuration to be fitted by a user to extend over a mouth and nostrils of the user on different size faces, having an initial flat trapezoidal configuration with a soft flexible compliant Opening on a base side of the trapezoidal configuration, without strips or metal clips, to block particulate material while enabling an inhalation and exhalation breathing pressure resistance of 25 mm or less when sealed to the user's face;
a pair of solid rib members are cantilevered to extend from the base side of the trapezoidal configuration to provide support for maintaining the filter material away from the user's mouth and nostrils; and
an adhesive layer extending around a perimeter of the base side opening of the filter material to seal the opening of the base side and to enable a sealing of the adhesive layer with the user's skin to provide a central concavity of a size to be offset from and to cover the user's mouth and nostrils.

16. The respiratory facial mask of claim 16 wherein the solid rib members and filter member are formed from plastic materials and the solid rib members are a sealed integral continuation of the same filter material which forms a top and bottom of the central concavity.

17. A method of manufacturing a respiratory facial mask, comprising the steps of:
providing a flexible filter member that blocks particles of 50 nm size while permitting 25 nm or less of inhalation and exhalation breathing pressure resistance, the filter member includes a tribo-electric charged polypropylene/acrylic filter media layer;
applying an acrylate adhesive layer on opposite ends of the flexible filter member;
folding the flexible filter member to form a top and bottom layer, with the ends of adhesive layers facing each other; and
sealing the opposite folded ends while forming integral solid plastic ribs from the polypropylene and acrylic material to extend from a flexible folded open end filter member having a perimeter of the adhesive layer to the folded closed end filter member, the solid plastic ribs providing a cantilevered structural strength to tent the flexible filter member to form a cavity across the mouth and nostrils of a user when the adhesive layer is affixed to skin of a user around the mouth and nostrils of the user.

18. The method of manufacturing of claim 17 wherein the sealing of the opposite folded sides also cuts the flexible filter member into a trapezoidal shape with the opening being the base of the trapezoid.

19. The method of manufacturing of claim 17 wherein the sealing is performed by ultrasonic welding.

20. The method of manufacturing of claim 19 wherein the solid plastic fibs form a pair of flanges that are approximately 1 mm thick and 2 mm wide to provide longitudinal strength for supporting the cantilevering of the flexible filter member while permitting transverse flexing.

21. The method of manufacturing of claim 18 wherein the flexible filter member is a tribo-electric charged polypropylene filter media layer with a melt blown surface layer.

22. The method of manufacturing of claim 21 further including applying a surface film of an antimicrobial material on the melt blown surface layer.

23. A method of customizing a respiratory facial mask to seal on a user's face comprising the steps of:
providing a flat trapezoidal flexible filter member with an opening perimeter of an adhesive member and a pair of integral side support plastic ribs;
forming a concave opening, in the flexible filter member, between the side support plastic ribs;
attaching the adhesive member over a bridge of a user's nose and below the eyes, with the side support plastic ribs cantilevered away from the user's face;
attaching the adhesive member under the user's chin adjacent the user's neck; and
pressing the adhesive layer firmly against the user's face to provide an airtight seal against the user's face.
